(19) United States
(12) Patent Application Publication
(10) Pub. No.: US 2021/0063752 A1
(43) Pub. Date: Mar. 4, 2021

(54) VIRTUAL IMAGE DISPLAY APPARATUS AND LIGHT-GUIDING DEVICE

(71) Applicant: SEIKO EPSON CORPORATION, Tokyo (JP)

(72) Inventors: Takashi TAKEDA, Suwa-shi (JP); Masayuki TAKAGI, Azumino-shi (JP); Toshiaki MIYAO, Matsumoto-shi (JP); Tokito YAMAGUCHI, Azumino-shi (JP); Mitsutaka IDE, Shiojiri-shi (JP)

(73) Assignee: SEIKO EPSON CORPORATION, Tokyo (JP)

(21) Appl. No.: 17/004,891

(22) Filed: Aug. 27, 2020

(30) Foreign Application Priority Data
Aug. 28, 2019 (JP) 2019-155537

(51) Int. Cl. G02B 27/01

(52) U.S. Cl. CPC G02B 27/0172; G02B 2027/0178; G02B 2027/0174

(57) ABSTRACT

A virtual image display apparatus includes a display element, an optical element configured to pass therethrough image light emitted from the display element, a reflecting mirror configured to reflect the image light emitted from the optical element, a see-through hologram mirror of a see-through type configured to reflect the image light, emitted from the reflecting mirror, to a pupil position, and a linear diffraction element of a transmissive type arranged on an optical path from the optical element to the hologram mirror. The optical element, the reflecting mirror, and the see-through hologram mirror are arranged to form an off-axis system, and the linear diffraction element compensates wavelength dispersion caused by the see-through hologram mirror at an off-axis surface of the off-axis system.

The present application is based on, and claims priority from JP Application Serial Number 2019-155537, filed Aug. 28, 2019, the disclosure of which is hereby incorporated by reference herein in its entirety.

### BACKGROUND

### 1. Technical Field

The present disclosure relates to a virtual image display apparatus such as a head-mounted display and a light-guiding device incorporated therein, and more particularly, to a virtual image display apparatus capable of providing see-through view.

### 2. Related Art

Various types of a virtual image display apparatus in which imaging light from a display element is guided to a pupil of an observer by an optical element such as a mirror are proposed as a virtual image display apparatus, which enables formation and observation of a virtual image, like a head-mounted display.

A virtual image observation optical system described in JP-A-11-326821 includes an image display device, an image formation optical element, and a reflection type diffraction optical element, and light emitted from the image display device is reflected by, for example, the image formation optical element, is reflected again by the reflection type diffraction optical element, and enters a pupil. In this case, the image formation optical element is an aspherical concave mirror arranged eccentrically, and the reflection type diffraction optical element is a reflection type blazed hologram, for example.

However, in the optical system in JP-A-11-326821, when light diffracted by the reflection type diffraction optical element includes light other than light having a predetermined wavelength, wavelength dispersion in which light is disadvantageously diffracted by the reflection type diffraction optical element at angles for different wavelengths is caused, which degrades a resolution.

### SUMMARY

A virtual image display apparatus according to one aspect of the present disclosure includes a display element, an optical element configured to pass therethrough image light emitted from the display element, a reflecting mirror configured to reflect the image light emitted from the optical element; a hologram mirror of a see-through type configured to reflect the image light, emitted from the reflecting mirror, to a pupil position, and a linear diffraction element of a transmissive typeg arranged at an optical path from the display element to the hologram mirror, wherein the optical element, the reflecting mirror, and the hologram mirror are arranged to form an off-axis system, and the linear diffraction element compensates wavelength dispersion caused by the hologram mirror at an off-axis surface of the off-axis system.

### BRIEF DESCRIPTION OF THE DRAWINGS

FIG. 1 is an external perspective view illustrating a state in which a virtual image display apparatus according to a first exemplary embodiment is worn.

FIG. 2 is a side cross-sectional view illustrating the virtual image display apparatus illustrated in FIG. 1.

FIG. 3 is a side cross-sectional view illustrating an internal structure of the virtual image display apparatus.

FIG. 4 is a side cross-sectional view and a plan view illustrating an optical system of the apparatus illustrated in FIG. 1.

FIG. 5 is an enlarged side cross-sectional view illustrating a linear diffraction element.

FIG. 6 is a perspective view schematically illustrating image formation performed by a projection optical system.

FIG. 7 is a diagram illustrating a compulsory distortion of a display image formed on a display element.

FIG. 8 is a side cross-sectional view illustrating an optical system incorporated in a virtual image display apparatus according to a second exemplary embodiment.

### DESCRIPTION OF EXEMPLARY EMBODIMENTS

### First Embodiment

Now, with reference to the drawings, a virtual image display apparatus and a light-guiding device incorporated therein according to a first exemplary embodiment of the present disclosure are described.

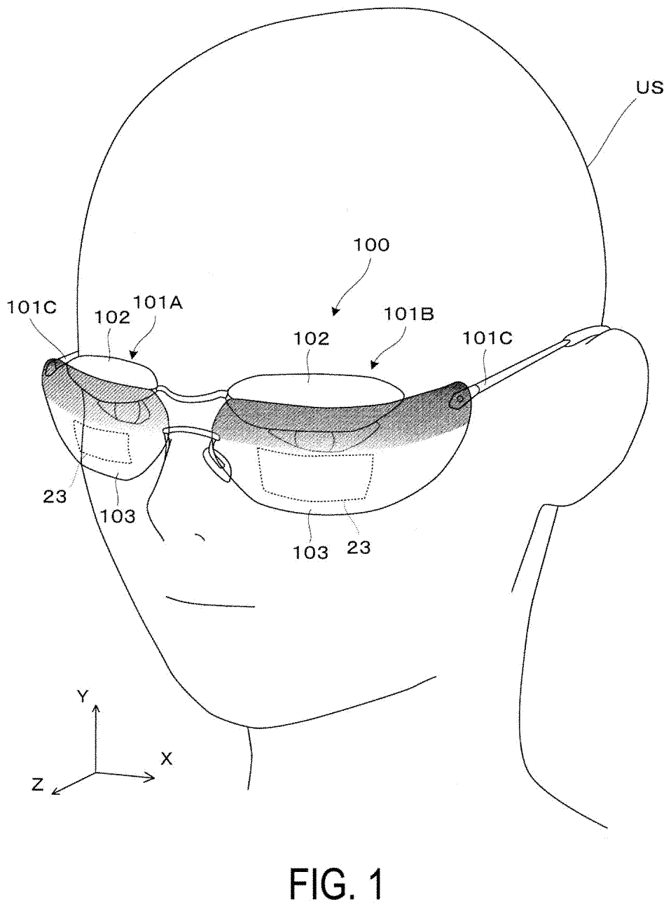

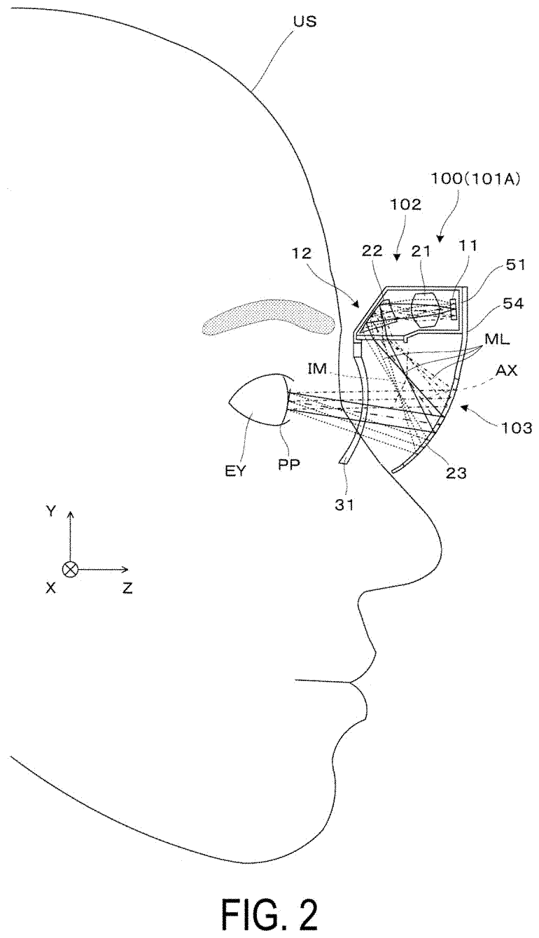

As illustrated in FIG. 1 and FIG. 2, a virtual image display apparatus 100 according to the first exemplary embodiment is a head-mounted display (HMD) having an appearance similar to eye glasses, and causes an observer or a user US wearing the apparatus to recognize an image being a virtual image. In FIG. 1 and FIG. 2, X, Y, and Z are an orthogonal coordinate system, a +X direction corresponds to a lateral direction in which both eyes of the user US wearing the virtual image display apparatus 100 are aligned, a +Y direction corresponds to an upward direction orthogonal to the lateral direction in which both the eyes of the user US are aligned, and a +Z direction corresponds to a front direction or a front surface direction of the user US.

The virtual image display apparatus 100 includes a first display device 101A that forms a virtual image with respect to a right eye, a second display device 101B that forms a virtual image with respect to a left eye, and temple-like support devices 101C that support both the display devices 101A and 101B. The first display device 101A includes an optical unit 102 arranged at an upper part and an external member 103 that has an eyeglass lens-like shape and covering the entirety. Similarly, the second display device 101B includes an optical unit 102 arranged at an upper part and an external member 103 that has an eyeglass lens-like shape and covering the entirety. The support devices 101C support both the display devices 101A and 101B at upper end sides of the external members 103 with members (not shown) arranged on back sides of the external members 103. The second display device 101B for the left eye has a structure similar to that of the first display device 101A for the right eye. In the following, the first display device 101A is described, and description for the second display device 101B is omitted.

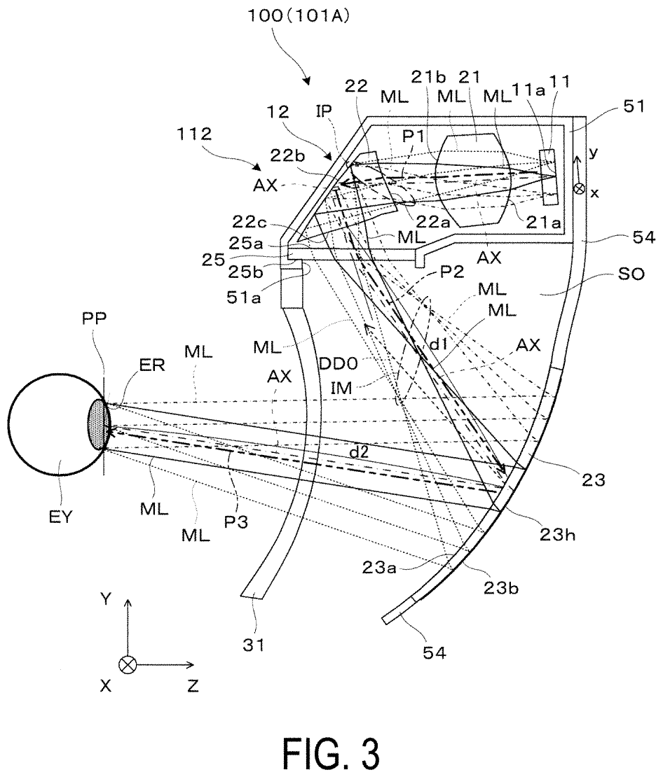

As illustrated in FIG. 2 and FIG. 3, the first display device 101A for the right eye includes a display element 11 and a projection optical system 12 as optical elements. The projection optical system 12 is also referred to as a light-guiding device in terms of guiding imaging light ML from the display element 11 to a pupil position PP.

The display element 11 is a self-luminous type display device typified by, for example, an organic electro-luminescence (organic EL), an inorganic EL, an LED array, an organic LED, a laser array, and a quantum dot emission type element, and forms a still image or a moving image in monochrome or color on a two-dimensional display surface 11a. The display element 11 is driven by a drive control circuit (not shown), and performs a display operation. When an organic EL display or a display device is used as the display element 11, the display element 11 includes an organic EL control unit. When a quantum dot display is used as the display element 11, a configuration of emitting green or red color can be achieved by causing light of a blue light emitting diode (LED) to pass through a pass through a quantum dot film, for example. The display element 11 is not limited to a self-luminous display element, and may be constituted by an LCD or other light modulating elements, and may form an image by illuminating the light modulating element with a light source such as a backlight. As the display element 11, a liquid crystal on silicon (LCOS, LCoS is a trade name), a digital micromirror device, and the like may be used instead of the LCD.

As illustrated in FIG. 3, the projection optical system (light-guiding device) 12 includes an optical element 21, a prism 22, a linear diffraction element 25, and a see-through hologram mirror 23. The optical element 21 condenses the image light ML emitted from the display element 11 in a state close to a parallel light flux. In the illustrated example, the optical element 21 is a single lens, and includes an incident surface 21a and an emission surface 21b. The prism 22 includes an incident surface 22a, an internal reflecting surface 22b, and an emission surface 22c. The image light ML emitted from the optical element 21 enters the incident surface 22a while being refracted, is totally reflected by the internal reflecting surface 22b, and is emitted from the emission surface 22c while being refracted. The linear diffraction element 25 is arranged in an optical path between the prism 22 and the see-through hologram mirror 23, and provides uniform wavelength dispersion to the image light ML with respect to a vertical direction on the paper sheet when the image light ML emitted from the prism 22 is caused to pass therethrough. The see-through hologram mirror 23 is a see-through type hologram mirror. The see-through hologram mirror 23 reflects the image light ML, which is emitted from the prism 22, toward the pupil position PP. The pupil position PP is a position that the image light from each point on the display surface 11a enters in a predetermined diverging state or a parallel state from an angle direction corresponding to a position of each point on the display surface 11a in a superimposing manner. The projection optical system 12 that is illustrated has a field of view (FOV) of 44 degrees. The display area for the virtual image, which is performed by the projection optical system 12, is rectangular, and 44 degrees described above corresponds to a diagonal direction.

The optical element 21 and the prism 22 are accommodated in a case 51 together with the display element 11. The case 51 is formed of a material having a light shielding property, and includes a drive circuit (not shown) for operating the display element 11, which is built therein. An opening 51a of the case 51 has a size that does not block the image light ML from the prism 22 toward the see-through hologram mirror 23. The opening 51a of the case 51 is covered with the linear diffraction element 25 having a flat plate-like shape extending substantially in a parallel manner on an XZ plane. The accommodation space in the case 51 can be sealed with the linear diffraction element 25, and functions such as dust proof and dew proof can be enhanced. Further, when the linear diffraction element 25 is arranged between the prism 22 and the see-through hologram mirror 23, the space for arranging the linear diffraction element 25 is easily secured. The case 51 supports the see-through hologram mirror 23 through intermediation of a support plate 54. The case 51 or the support plate 54 is supported by the support devices 101C illustrated in FIG. 1, and the external member 103 is constituted by the support plate 54 and the see-through hologram mirror 23.

The projection optical system 12 is an off-axis optical system, and the optical element 21, the prism 22, the linear diffraction element 25, and the see-through hologram mirror 23 are arranged to form an off-axis system 112. The expression that the projection optical system 12 is an off-axis optical system indicates that an optical path as a whole is bent before or after a light beam enters at least one reflecting surface or refracting surface in the optical elements 21, 22, and 23 constituting the projection optical system 12. In the projection optical system 12, that is, the off-axis system 112, an optical axis AX is refracted, and thus the optical axis AX extends along an off-axis surface SO corresponding to the paper sheet. Specifically, in the projection optical system 12, the optical axis AX is refracted in the off-axis surface SO, and thus the optical elements 21, 22, and 23 are arrayed along the off-axis surface SO. The off-axis surface SO is a surface that causes asymmetry in the off-axis system 112 at multi steps. The optical axis AX extends along an optical path of a main optical beam emitted from the center of the display element 11, and passes through an eye ring ER corresponding to an eye point or the center of the eye. Specifically, the off-axis surface SO on which the optical axis AX is arranged is parallel with a YZ plane, and passes through the center of the display element 11 and the center of the eye ring ER corresponding to an eye point. When seen in a lateral cross-section, the optical axis AX is arranged in a Z-like shape. Specifically, on the off-axis surface SO, an optical path P1 from the optical element 21 to the internal reflecting surface 22b, an optical path P2 from the internal reflecting surface 22b to the see-through hologram mirror 23, and an optical path P3 from the see-through hologram mirror 23 to the pupil position PP are arranged to be folded twice in a Z-like shape.

In the projection optical system 12, the optical path P1 from the optical element 21 to the internal reflecting surface 22b is close to a state parallel with the Z direction. Specifically, in the optical path P1, the optical axis AX extends substantially parallel with the Z direction or the front surface direction. As a result, the optical element 21 being a lens is arranged to be sandwiched between the prism 22 and the display element 11 with respect to the Z direction or the front surface direction. In this case, the optical path P1 from the prism 22 to the display element 11 is close to the front surface direction. The optical axis AX in the optical path P1 preferably falls within a range of from approximately −30 degrees to +30 degrees on average with a downward direction in the Z direction corresponds to a negative. The optical axis AX in the optical path P1 is in a downward state in the Z direction at −30 degrees or more, and thus the optical element 21 and the display element 11 can be prevented from interfering with the see-through hologram mirror 23. Further, the optical axis AX in the optical path P1 is in an upward state in the Z direction at +30 degrees or less, and thus the optical element 21 and the display element 11 can be prevented from protruding upward and being conspicuous on appearance. In the optical path P2 from the internal reflecting surface 22b to the see-through hologram mirror 23, the optical axis AX preferably falls within a range of from approximately −70 degrees to −45 degrees on average with the downward direction in the Z direction corresponding to a negative. The optical axis AX in the optical path P2 is in a downward state in the Z direction at −70 degrees or more. Thus, a space for arranging an inner lens 31 can be secured between the see-through hologram mirror 23 and the pupil position PP, and the entire inclination of the see-through hologram mirror 23 can be prevented from being excessively increased. Further, the optical axis AX in the optical path P2 is in a downward state in the Z direction at −45 degrees or less. Thus, the prism 22 can be prevented from being arranged to largely protrude with respect to the see-through hologram mirror 23 in −the Z direction or the back surface direction, and the projection optical system 12 can be prevented from being increased in thickness. The optical path P3 from the see-through hologram mirror 23 to the pupil position PP is close to a state parallel with the Z direction. In the illustrated example, the optical axis AX is at approximately −10 degrees with the downward direction in the Z direction corresponding to a negative. This is because a human line-of-sight is stabilized with slightly downcast eyes, which are inclined downward from the horizontal direction at approximately 10 degrees. Note that a center axis HX in the horizontal direction with respect to the pupil position PP is set by assuming that the user US wearing the virtual image display apparatus 100 gazes steadily in the horizontal direction or the horizontal line while facing the front in an upright posture and in a relaxed state. A shape and a posture of a head including arrangement of eyes, arrangement of ears, and the like vary depending on users US wearing the virtual image display apparatus 100.

By assuming an average head shape and head posture of the users US, the average center axis HX can be set for the subject virtual image display apparatus 100. As a result from the description given above, on the internal reflecting surface 22b of the prism 22, an incident angle and a reflection angle of a light beam along the optical axis AX are approximately from 40 degrees to 70 degrees, for example. Further, on the see-through hologram mirror 23, an incident angle and a reflection angle of a light beam along the optical axis AX is approximately from 20 degrees to 50 degrees, for example. Note that, on the see-through hologram mirror 23, a difference between the incident angle and the reflection angle is approximately 15 degrees, which is described later in detail.

With regard to the optical path P2 and the optical path P3 of the main optical beam, a distance d1 between the see-through hologram mirror 23 and the linear diffraction element 25 is equal to or less than a distance d2 between the see-through hologram mirror 23 and the pupil position PP. In this case, a projection amount by which the optical element 21 and the prism 22 protrude in a periphery of the see-through hologram mirror 23, that is, protrude upward can be suppressed. Here, the distances d1 and d2 are considered on the optical axis AX. When an additional optical element is arranged on the optical paths P2 and P3 on an inner side of the see-through mirror 23, the optical element is converted into an optical length or an optical distance, and values for the distances d1 and d2 are determined.

In the projection optical system 12, the position of the light beam passing through the uppermost side in the vertical direction is equal to or less than 30 mm with respect to the vertical direction or the Y direction with the pupil position PP as a reference, more specifically, the center thereof as a reference. When the light beam falls within the range described above, the optical element 21 and the display element 11 can be prevented from being arranged to protrude in the upward direction or +the Y direction, and an amount by which the optical element 21 and the display element 11 expand upward of an eyebrow can be suppressed. With this, designability can be secured. Specifically, the optical unit 102 including the display element 11, the optical element 21, and the prism 22 can be reduced in size. Further, in the projection optical system 12, the position of all the light beams from the see-through hologram mirror 23 to the display element 11 is 13 mm or more with respect to the front surface direction or the Z direction with the pupil position PP as a reference. The light beams fall within the range described above. With this, particularly, the see-through hologram mirror 23 can be arranged to be sufficiently away from the pupil position PP in the front surface direction or +the Z direction, and the space for arranging the inner lens 31 is easily secured behind the see-through hologram mirror 23. Further, in the projection optical system 12, the position of all the light beams from the see-through hologram mirror 23 to the display element 11 is 40 mm or less with respect to the front surface direction or the Z direction with the pupil position PP as a reference. The light beams fall within the range described above. With this, particularly, the see-through hologram mirror 23 can be arranged not to be excessively away from the pupil position PP in the front surface direction or +the Z direction, and the see-through hologram mirror 23, the display element 11, and the like are prevented from protruding frontward. Thus, designability is secured easily. The linear diffraction element 25 is arranged at the position of 10 mm or more with respect to the vertical direction or the Y direction with the pupil position PP as a reference, more specifically, with the center thereof as a reference. With this, for example, a see-through visual field in the upward direction at 20 degrees is secured easily.

On the off-axis surface SO, an intermediate pupil IP is arranged between the optical element 21 and the internal reflecting surface 22b of the prism 22 on a side closer to the incident surface 22a of the prism 22 with respect to the optical element 21 and the internal reflecting surface 22b, with the optical axis AX as a reference. Further, when the intermediate pupil IP is arranged between the optical element 21 and the internal reflecting surface 22b, a focal distance is easily reduced, and a magnification is easily increased. Thus, while the display element 11 approaches the internal reflecting surface 22b and the like, the display element 11 can be small. More specifically, the intermediate pupil IP is arranged at the position of or in the vicinity of the incident surface 22a of the prism 22. The intermediate pupil IP may intersect the incident surface 22a of the prism 22. The intermediate pupil IP indicates a position at which the image light from each point on the display surface 11a spreads most largely and overlaps with each other, and is arranged at a conjugate point with the eye ring ER or the pupil position PP. At the position of the intermediate pupil IP or in the vicinity thereof, an aperture stop is preferably arranged.

An intermediate image IM is formed between the linear diffraction element 25 and the see-through hologram mirror 23. The intermediate image IM is formed closer to the linear diffraction element 25 with respect to the see-through hologram mirror 23. As described above, the intermediate image IM is formed to be close to the linear diffraction element 25 with respect to the see-through hologram mirror 23. With this, a load of magnification due to the see-through hologram mirror 23 is reduced, and hence aberration of a virtual image to be observed can be suppressed. However, the intermediate image IM is not in a state of intersecting the linear diffraction element 25. Specifically, the intermediate image IM is formed on the outer side of the linear diffraction element 25, and the arrangement relationship is established not only on the off-axis surface SO but also at a free-selected point in the lateral direction or the X direction perpendicular to the off-axis surface SO. As described above, the intermediate image IM is formed not to transect the linear diffraction element 25. With this, dust or scratches on the surface of the linear diffraction element 25 can be easily prevented from affecting image formation. The intermediate image IM is an actual image formed at a conjugate position with respect to the display surface 11a on the optical upstream to the eye ring ER, and has a pattern corresponding to a display image on the display surface 11a. However, the intermediate image IM is not required to be formed sharply, and may express various types of aberration such as field curvature and distortion aberration. When aberration is satisfactorily corrected for a virtual image to be observed at the pupil position PP at the final stage, aberration of the intermediate image IM does not cause any problem.

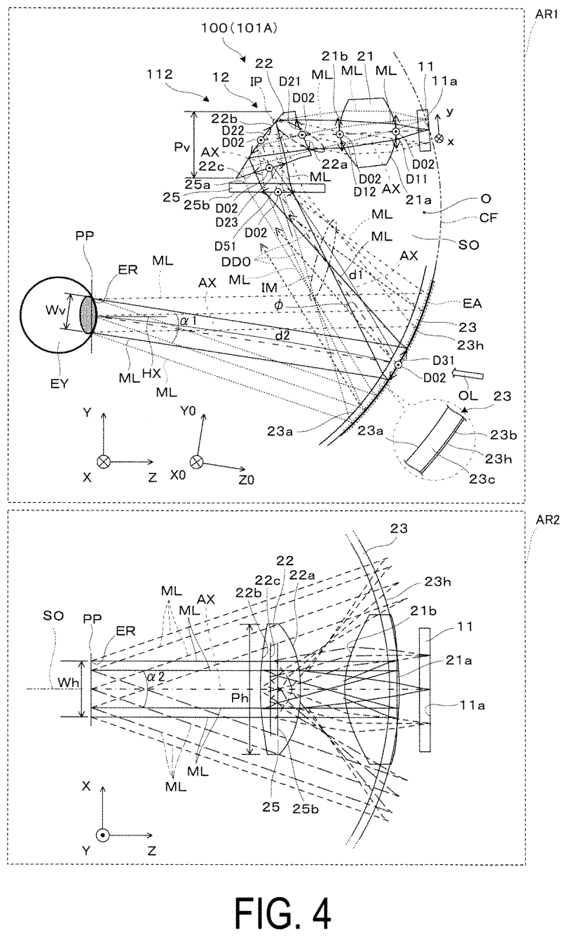

With reference to FIG. 4, shapes of the optical element 21, the prism 22, and the see-through hologram mirror 23 are described in detail. In FIG. 4, an area AR1 indicates a side cross-sectional view of the projection optical system 12, and an area AR2 indicates a plan view of the projection optical system 12. Note that, in the area AR2, the optical surfaces 21a and 21b of the optical element 21, the optical surfaces 22a, 22b, and 22c of the prism 22, a diffraction surface 25b of the linear diffraction element 25, and surfaces 23a and 23b of the see-through hologram mirror 23 are illustrated as surfaces projected on the XZ plane after passing through the optical axis AX.

In this case, the optical element 21 is formed of a single lens, and adjusts a state of a light beam when the image light ML is caused to pass therethrough. The incident surface 21a and the emission surface 21b being optical surfaces constituting the optical element 21 are asymmetric across the optical axis AX with respect to first vertical directions D11 and D12 intersecting the optical axis AX on the off-axis surface SO in parallel with the YZ plane, and are symmetric across the optical axis AX with respect to a second lateral direction D02 or the X direction orthogonal to the first directions D11 and D12. The first vertical direction D11 with respect to the incident surface 21a and the second vertical direction D12 with respect to the emission surface 21b form a predetermined angle. The optical element 21 is made of, for example, a resin, but may also be made of glass. For example, the incident surface 21a and the emission surface 21b of the optical element 21 are free curved surfaces. The incident surface 21a and the emission surface 21b are not limited to free curved surfaces, and may be aspherical surfaces. In the optical element 21, aberration can be reduced by setting the incident surface 21a and the emission surface 21b to be a free curved surface or an aspherical surface, and, particularly when a free curved surface is used, aberration of the projection optical system 12 being an off-axis optical system or a non-coaxial optical system can be easily reduced. Note that the free curved surface is a surface without an axis of rotational symmetry, and various polynomials may be used as a surface function of the free curved surface. In addition, the aspherical surface is a surface having an axis of rotational symmetry, but is a paraboloid or a surface other than a spherical surface expressed by a polynomial. Detailed description is omitted, but an antireflective film is formed on the incident surface 21a and the emission surface 21b.

As described above, on the optical element 21, the first direction D11 of the incident surface 21a and the second direction D12 of the emission surface 21b form the predetermined angle. As a result, with regard to the optical path of the main optical beam from the center of the display surface 11a of the display element 11, the emission surface 21b is formed to be inclined with respect to the incident surface 21a. Specifically, a relative angle or inclination is present between the incident surface 21a and the emission surface 21b. The optical element 21 may have a function of partially compensating eccentricity of the projection optical system 12 as the off-axis system 112, which contributes to improvement in various aberration.

The prism 22 is a refraction/reflection optical member having a function obtained by combining a mirror and a lens, and refracts and reflects the image light ML from the optical element 21. More specifically, the image light ML enters the inside of the prism 22 through the incident surface 22a being a refracting surface, is totally reflected by the internal reflecting surface 22b being a reflecting surface in an irregular reflection direction, and is emitted to the outside through the emission surface 22c being a refracting surface. The incident surface 22a and the emission surface 22c are optical surfaces formed of curved surfaces, and contribute to improvement of a resolution as compared to a case where only a reflecting surface is adopted or flat surfaces are adopted. The incident surface 22a, the internal reflecting surface 22b, and the emission surface 22c being optical surfaces constituting the prism 22 are asymmetric across the optical axis AX with respect to first vertical directions D21, D22, and D23 intersecting the optical axis AX on the off-axis surface SO in parallel with the YZ plane, and are symmetric across the optical axis AX with respect to the second lateral direction D02 or the X direction orthogonal to the first directions D21, D22, and D23. The prism 22 or the internal reflecting surface (reflecting mirror) 22b has a lateral width Ph in the lateral direction or the X direction, which is larger than a vertical width Pv in the vertical direction or the Y direction. With regard to an optically effective area of the prism 22 as well as its appearance, the lateral width in the lateral direction or the X direction is larger than the vertical width in the vertical direction or the Y direction. With this, an angle of view in the lateral direction or the Y direction can be increased. Further, as described later, even when a line-of-sight is largely changed in a lateral direction correspondingly to an eye EY that moves largely in a lateral direction, an image can be visually recognized.

The prism 22 is made of, for example, a resin, but may also be made of glass. A refractive index of the prism 22 itself is set to a value that enables total reflection on the internal surface in consideration of a reflection angle of the image light ML. A refractive index and an abbe number of the prism 22 itself are preferably set in consideration with a relationship with the optical element 21. For example, the optical surfaces of the prism 22, specifically, the incident surface 22a, the internal reflecting surface 22b, and the emission surface 22c are free curved surfaces. The incident surface 22a, the internal reflecting surface 22b, and the emission surface 22c are not limited to free curved surfaces, and may be aspherical surfaces. In the prism 22, aberration reduction can be achieved by setting the optical surfaces 22a, 22b, and 22c to be a free curved surface or an aspherical surface, and, particularly when a free curved surface is used, aberration of the projection optical system 12 being an off-axis optical system or a non-coaxial optical system can be easily reduced. With this, a resolution can be improved. The internal reflecting surface 22b is not limited to a reflecting surface that reflects the image light ML with total reflection, and may be a reflecting surface formed of a metal film or a dielectric multilayer film. In this case, on the internal reflecting surface 22b, a reflecting film formed of a single film or a multilayer film formed of metal such as Al and Ag is formed by vapor deposition or the like, or a sheet-like reflecting film formed of metal is attached. Detailed description is omitted, but an antireflective film is formed on the incident surface 22a and the emission surface 22c.

With regard to the prism 22, the incident surface 22a, the internal reflecting surface 22b, and the emission surface 22c can be collectively formed by injection molding. Thus, the number of components can be reduced, and relative positions of the three surfaces can be highly accurate at a level of, for example, 20 μm or less at a relatively low cost.

The linear diffraction element 25 is a flat plate-like optical member, and is arranged substantially in a parallel manner on the XZ plane. The linear diffraction element 25 is a transmissive element, and compensates wavelength dispersion, which is caused by the see-through hologram mirror 23, by diffracting the image light ML from the prism 22 with predetermined chromatic dispersion. More specifically, the linear diffraction element 25 includes an incident surface 25a and the diffraction surface 25b, and the transmissive diffraction surface 25b diffracts the image light ML with the predetermined wavelength dispersion. The incident surface 25a is a flat surface without a curvature. An antireflective film is formed on the incident surface 25a. The diffraction surface 25b is a flat surface macroscopically, but has a diffraction structure microscopically. The linear diffraction element 25 is made of, for example, glass, but may also be made of a resin.

As apparent from the fact that the linear diffraction element 25 has a parallel flat plate-like shape, the incident surface 25a and the diffraction surface 25b constituting the linear diffraction element 25 have a uniform optical property with respect to a first vertical direction D51 intersecting the optical axis AX on the off-axis surface SO in parallel with the YZ plane, and are asymmetric across the optical axis AX with respect to the second lateral direction D02 or the X direction orthogonal to the first direction D51.

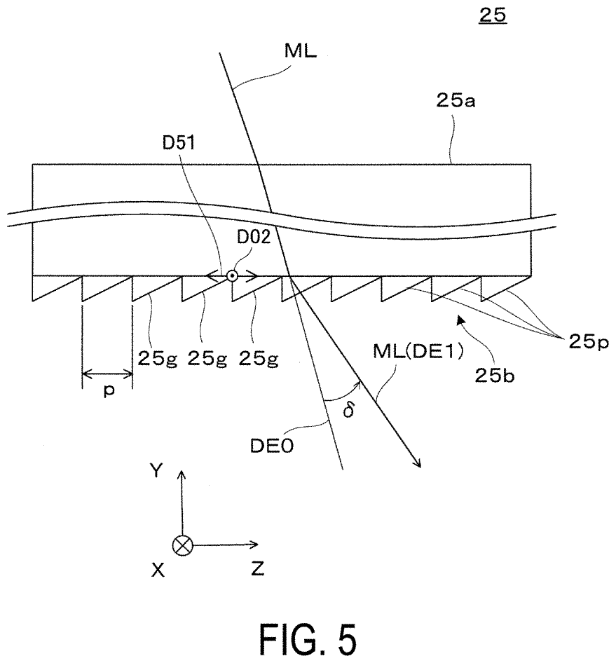

As illustrated in FIG. 5 in an enlarged manner, the linear diffraction element 25 is a blazed diffraction grating, includes a diffraction pattern 25p extending in the X direction perpendicular to the off-axis surface SO of the off-axis system 112, and compensates wavelength dispersion in a direction along the off-axis surface SO with the diffraction pattern 25p. The diffraction surface 25b of the linear diffraction element 25 has a lateral cross section having a triangular shape or a serrated shape as the diffraction pattern 25p, and has a step-like structure as a whole. The linear diffraction element 25 is an element that performs uniform diffraction on the off-axis surface SO or the YZ plane. Specifically, the diffraction pattern 25p in the illustration extends in the X direction, and is uniformly repeated in the Z direction or the first direction D51. Even when the linear diffraction element 25 moves in the first direction D51 or the second direction D02 being a direction parallel with the incident surface 25a, a diffraction property is not changed. Thus, arrangement accuracy required for the linear diffraction element 25 can be relatively lowered. Here, the linear diffraction element 25 is a blazed diffraction grating, and hence optical attenuation due to the linear diffraction element 25 can be suppressed, which contributes to improvement of brightness of a virtual image. In the illustrated example, when it is assumed that the image light ML is single color light, primary diffraction light DE1 is extracted with respect to the image light ML entering the diffraction surface 25b. When the primary diffraction light is used as the image light ML in place of primary or more diffraction light, utilization efficiency of light extracted from the linear diffraction element 25 can be improved. Grating surfaces 25g constituting the diffraction surface 25b are substantially orthogonal to the image light ML emitted from the linear diffraction element 25. In this case, utilization efficiency of light extracted from the diffraction surface 25b or the linear diffraction element 25 is further improved. An angle δ of the primary diffraction light DE1 with respect to zero-order light DE0 is determined based on a wavelength of the image light ML, a grating interval, a refractive index of the base material, and the like, and is set in consideration with an extent of compensation of wavelength dispersion. In the specific example, the angle δ is approximately from 15 degrees to 30 degrees. When the angle δ of the primary diffraction light DE1 is 10 degrees or less, it is highly possible that the primary diffraction light DE1 is observed as a ghost while overlapping with the zero-order light DE0. When it is assumed that the image light ML is monochrome light, and includes light having a wavelength falling within a range of ±5 nm of a fundamental wavelength, for example, during compensation of wavelength dispersion, which is performed by the blazed diffraction grating, deviation in an emitting direction due to such a wavelength difference is canceled, and deviation depending on a wavelength in the emitting direction of the image light ML emitted from the see-through hologram mirror 23 is prevented from being caused. In the specific example, an periodic interval of the grating surfaces 25g is approximately from 1 μm to 4 μm.

Referring back to FIG. 4 and the like, the see-through hologram mirror 23 is a plate-like optical member curved in a spherical shape, and reflects the image light ML, which is emitted from the prism 22 and enters through the linear diffraction element 25. The see-through hologram mirror 23 covers the pupil position PP at which the eye EY or the pupil is arranged, and has a concave shape recessed toward the pupil position PP. The see-through hologram mirror 23 includes the pair of surfaces 23a and 23b, has an antireflective film formed on the surface 23a on the far side, that is, the pupil position PP side, and has a hologram layer 23h formed on the surface 23b on the front side, that is, the +Z side. The hologram layer 23h is a volume hologram of a transmissive reflection type, and is a thin film on which a three-dimensional interference pattern is formed. At the time of reflecting the image light ML, the hologram layer 23h diffracts the image light ML non-linearly with respect to the off-axis surface SO parallel with the YZ plane in accordance with desired optical power, and guides, to the pupil position PP, the image light ML as a light flux being parallel or having desired divergence. Note that, the surface 23a of the see-through hologram mirror 23 scarcely contributes to image formation, and has a shape similar to that of the surface 23b.

A plate-like body 23c being a base material of the see-through hologram mirror 23 is made of, for example, a resin, but may also be made of glass. The plate-like body 23c is formed of the same material as that of the support plate 54 supporting the plate-like body 23c from the periphery, and has the same or approximate thickness as that of the support plate 54. The hologram layer 23h may be formed directly on the plate-like body 23c. For example, a hologram photosensitive material is attached or applied on the surface 23b of the see-through hologram mirror 23. After that, object light is caused to enter the hologram photosensitive material layer from the pupil position PP side, and at the same time, the hologram photosensitive material is irradiated with reference light from the linear diffraction element 25 side. With this, exposure for forming a refractive index pattern in the hologram photosensitive material layer is performed, and the hologram layer 23h is completed.

The surface 23b of the see-through hologram mirror 23 is asymmetric across the optical axis AX with respect to a first vertical direction D31 intersecting the optical axis AX on the off-axis surface SO in parallel with the YZ plane, and is symmetric across the optical axis AX with respect to the second lateral direction D02 or the X direction orthogonal to the first direction D31. The surface 23b of the see-through hologram mirror 23 is, for example, a free curved surface. The surface 23b is not limited to a free curved surface, and may be an aspherical surface. The surface 23b of the see-through hologram mirror 23 is designed to have optical power that contributes to image formation of the image light ML with respect to the second direction D02 or the X direction. Specifically, the hologram layer 23h has a diffraction effect that contributes to image formation with respect to a direction along the first direction D31 or the off-axis surface SO, and scarcely contributes to image formation the X direction perpendicular to the second direction D02 or the off-axis surface SO. In view of such circumstance, aberration can be reduced mainly with respect to the X direction perpendicular to the off-axis surface SO by setting the see-through mirror 23 to be a free curved surface or an aspherical surface. Particularly, when a free curved surface is used, aberration of the projection optical system 12 being an off-axis optical system or a non-coaxial optical system can be easily reduced. When the surface 23b is any one of a free curved surface and an aspherical surface, the see-through hologram mirror 23 has a shape in which an original point O in a curved surface expression is shifted to a side of the optical element 21 or a side of the display element 11 with respect to an effective area EA of the see-through hologram mirror 23. In this case, without putting an excessive load to design of the optical system, particularly, the surface 23b, an inclination surface of the see-through mirror, which achieves the Z-like shape optical paths, can be set. The curved surface expression of the surface 23b described above is as indicated with the two-dot dashed curved line CF on the off-axis surface SO, for example. Thus, the original point O providing symmetry is arranged between the upper end of the see-through mirror 23 and the lower end of the display element 11.

When the image light ML, which is emitted from the prism 22 and enters the hologram layer 23h through the linear diffraction element 25, is diffracted toward the −Z direction, the see-through hologram mirror 23 emits the image light ML in the downward direction or the −Y direction as compared to a regular reflection. When a light beam moving backward from the center of the pupil position PP is considered, a direction of regular reflection from the hologram layer 23h, that is, zero-order light DD0 is in a downward direction with respect to the image light ML, and does not enter the linear diffraction element 25 or the prism 22. Specifically, on the off-axis surface SO of the off-axis system 112, the hologram layer 23h of the see-through hologram mirror 23 is oriented to a direction close to the optical axis AX on the emission side of the hologram layer 23h with respect to the optical axis AX on the incident side of the hologram layer 23h. In this case, the posture of the see-through hologram mirror 23 can be close to the vertical direction or the Y direction in parallel with the eye ring ER of the pupil position PP, and the see-through hologram mirror 23 can be prevented from being increased in thickness in the front-and-rear direction, that is, in the +Z direction. When an angle φ of the zero-order light DD0 with respect to the image light ML is approximately from 10 degrees to 15 degrees, the zero-order light from the see-through hologram mirror 23 can be prevented from entering the pupil position PP although it depends on the distance d1 between the see-through hologram mirror 23 and the linear diffraction element 25.

The see-through hologram mirror 23 is a transmissive reflection element that cause light to partially pass through at the time of reflection, and the hologram layer 23h of the see-through hologram mirror 23 has a semi-transmissive property. With this, external light OL passes through the see-through hologram mirror 23, and thus see-through view of externals is enabled, and a virtual image can be superimposed on an external image. At this time, when the plate-like body 23c has a thickness of less than or equal to approximately few millimeters, a change in magnification of the external image can be suppressed to low. A reflectance of the hologram layer 23h with respect to the external light OL is set to fall within a range of from 10% to 50% in terms of securing luminance of the imaging light ML and facilitating observation of an external image by see-through.

In the description given above, it is assumed that wavelength dispersion of the see-through hologram mirror 23 is larger than that of the prism 22 or the optical element 21, and wavelength dispersion of the see-through hologram mirror 23 is compensated by the linear diffraction element 25. However, when wavelength dispersion of the prism 22 or the optical element 21 is larger than that of the see-through hologram mirror 23 to a non-negligible extent, wavelength dispersion obtained by adding an impact of wavelength dispersion of the prism 22 or the optical element 21 to wavelength dispersion of the see-through hologram mirror 23 may be compensated by the linear diffraction element 25.

In the description given above, description is made on a case where the image light ML is monochrome light when wavelength dispersion of the see-through hologram mirror 23 is compensated by the linear diffraction element 25. However, when the image light ML is color light, the hologram layer 23h of the see-through hologram mirror 23 is required to correspond to, for example, three colors of RGB, and may be a lamination body obtained by, for example, laminating three hologram element layers that are produced to correspond to the colors of RGB. Further, the linear diffraction element 25 may be formed as a lamination body obtained by laminating a plurality of hologram element layers as a volume hologram so as to correspond to a chromatic dispersion property of RGB of the hologram layer 23h. Also in this case, the linear diffraction element 25 is an element that performs uniform diffraction on the off-axis surface SO or the YZ plane. Even when the linear diffraction element 25 moves in a direction parallel with the incident surface 25a, a diffraction property is not changed.

Description is made on the optical paths. The image light ML from the display element 11 enters the optical element 21, and is emitted in a substantially collimated state. The image light ML passing through the optical element 21 enters the prism 22, is refracted by the incident surface 21a, is reflected by the internal reflecting surface 22b at a reflectance close to 100%, and is refracted again and emitted by the emission surface 22c. The image light ML from the prism 22 enters the see-through hologram mirror 23 through the linear diffraction element 25, is diffracted by the hologram layer 23h, and is folded back in a substantially collimated state toward the pupil position PP. The image light ML reflected by the see-through hologram mirror 23 enters the pupil position PP at which the eye EY or the pupil of the user US is arranged. The intermediate image IM is formed close to the emission surface 22c of the prism 22 between the prism 22 and the see-through hologram mirror 23. The intermediate image IM is obtained by appropriately enlarging an image formed on the display surface 11a of the display element 11. The external light OL that passes through the see-through hologram mirror 23 and the support plate 54 in the periphery also enters the pupil position PP. Specifically, the user US wearing the virtual image display apparatus 100 can observe a virtual image formed by the image light ML in a superimposing manner with the external image.

As apparent from comparison between the areas AR1 and AR2 in FIG. 4, in the FOV of the projection optical system 12, a lateral visual field angle α1 is larger than a vertical visual field angle α2. This corresponds to the fact that a display image formed on the display surfacella of the display element 11 is elongated in the horizontal direction. A width-to-height aspect ratio is set to a value of, for example, 4:3 or 16:9.

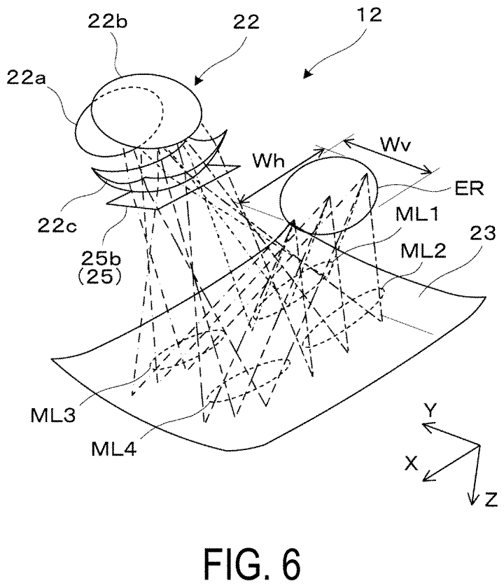

FIG. 6 is a perspective view schematically illustrating image formation performed by the projection optical system 12. In the drawing, an image light ML1 indicates a light beam from the upward-right direction in the visual field, an image light ML2 indicates a light beam from the downward-right direction in the visual field, an image light ML3 indicates a light beam from the upward-left direction in the visual field, and an image light ML4 indicates a light beam from the downward-left direction in the visual field. In this case, the eye ring ER that is set at the pupil position PP has a lateral pupil size WH in the lateral direction or the X direction perpendicular to the off-axis surface SO. The lateral pupil size Wh has an eye ring shape or a pupil size that is larger than a vertical pupil size Wv in the vertical direction or the Y direction orthogonal to the optical axis AX on the off-axis surface SO. Specifically, the pupil size at the pupil position is larger in the lateral direction or the X direction orthogonal to the off-axis surface SO than in the vertical direction or the Y direction orthogonal to the lateral direction. In a case where the lateral angle of view or visual field is larger than the vertical angle of view or visual field, when a line-of-sight is changed in accordance with the angle of view, the position of the eye largely moves in the lateral direction. Thus, the pupil size is preferably increased in the lateral direction. Specifically, the line-of-sight is largely changed in the lateral direction, the image can be prevented or suppressed from being cut by setting when the lateral pupil size Wh of the eye ring ER to be larger than the vertical pupil size Wv. In a case of the projection optical system 12 illustrated in FIG. 4, the FOV is large in the lateral direction, and is small in the vertical direction. As a result, the eye EY or the pupil of the user US rotates within an angle range that is laterally large, and rotates within an angle range that is vertically small. Thus, in accordance with motion of the eye EY, the lateral pupil size Wh of the eye ring ER is larger than the vertical pupil size Wv of the eye ring ER. As apparent from the description given above, for example, when the FOV of the projection optical system 12 is set to be larger in the vertical direction than in the lateral direction, the lateral pupil size Wh of the eye ring ER is preferably smaller than the vertical pupil size Wv of the eye ring ER. In the above, when the optical axis AX from the see-through hologram mirror 23 to the pupil position PP is orientated downward, the inclination of the eye ring ER and the size of the eye ring ER in a strict sense are required to be considered with coordinate systems X0, Y0, and Z0 orientated downward with the optical axis AX as a Z0 direction, as a reference. In this case, a vertical Y0 direction is not the vertical direction or the Y direction in a strict sense. However, in a case where the inclination as described above is not large, when consideration is taken with the coordinate systems X, Y, and Z, a problem is not caused in the inclination of the eye ring ER and the size of the eye ring ER in an approximate sense.

Although illustration is omitted, when the FOV of the projection optical system 12 is larger in the lateral direction than in the vertical direction in accordance with a size relationship between the lateral pupil size Wh and the vertical pupil size Wv of the eye ring ER, the intermediate pupil IP is also preferably set so that the lateral pupil size in the X direction is smaller than the vertical pupil size in the Y direction.

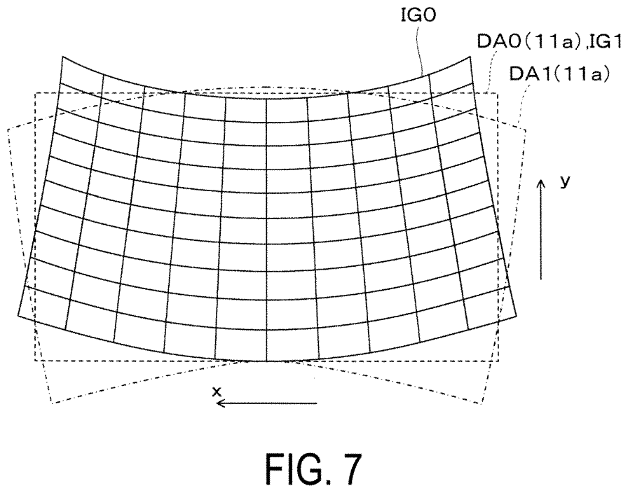

As illustrated in FIG. 7, an actual projection image IG0 expressing the image formation state by the projection optical system 12 has a relatively large distortion. The projection optical system 12 is the off-axis system 112, and hence it is not easy to remove all distortion such as a trapezoidal distortion. Thus, in a case where an original display image is indicated with DA0 even when a distortion remains in the projection optical system 12, an image to be formed on the display surfacella is indicated as a modification image DA1 with a trapezoidal distortion provided with a distortion in advance. Specifically, the image displayed on the display element 11 has a reversed distortion that cancels the distortion formed by the optical element 21, the prism 22, and the see-through hologram mirror 23. With this, pixel arrangement of a virtual projection image IG1 observed at the pupil position PP through the projection optical system 12 can be a grid pattern corresponding to the original display image DA0, and the contour can be rectangular. As a result, distortion aberration generated at the see-through hologram mirror 23 or the like is allowed, and aberration as a whole including the display element 11 can be suppressed. When the display surface 11a is rectangular, a margin is formed by forming a compulsory distortion, but additional information may be displayed in such a margin. The display image DA1 formed on the display surface 11a is not limited to a display image in which a compulsory distortion is formed by image processing, and, for example, an array of display pixels formed on the display surface 11a may correspond to a compulsory distortion. In this case, image processing for correcting the distortion is not required. Further, the display surface 11a may be curved to correct aberration.

In the virtual image display apparatus 100 according to the first exemplary embodiment described above, the optical element 21, the internal reflecting surface (reflecting mirror) 22b, and the see-through hologram mirror 23 are arranged to form the off-axis system 112. While generation of aberration is suppressed by the internal reflecting surface (reflecting mirror) 22b and the see-through hologram mirror 23, size reduction of the optical system and size reduction of the apparatus as a whole can be achieved. Further, the linear diffraction element 25 compensates wavelength dispersion caused by the see-through hologram mirror 23 on the off-axis surface SO of the off-axis system 112, and hence a resolution of a virtual image displayed by the virtual image display apparatus 100 can be improved.

### Second Embodiment

Now, a virtual image display apparatus and the like according to a second exemplary embodiment of the present disclosure are described. Note that the virtual image display apparatus according the second exemplary embodiment is obtained by modifying a part of the virtual image display apparatus according to the first exemplary embodiment, and description on common portions is omitted.

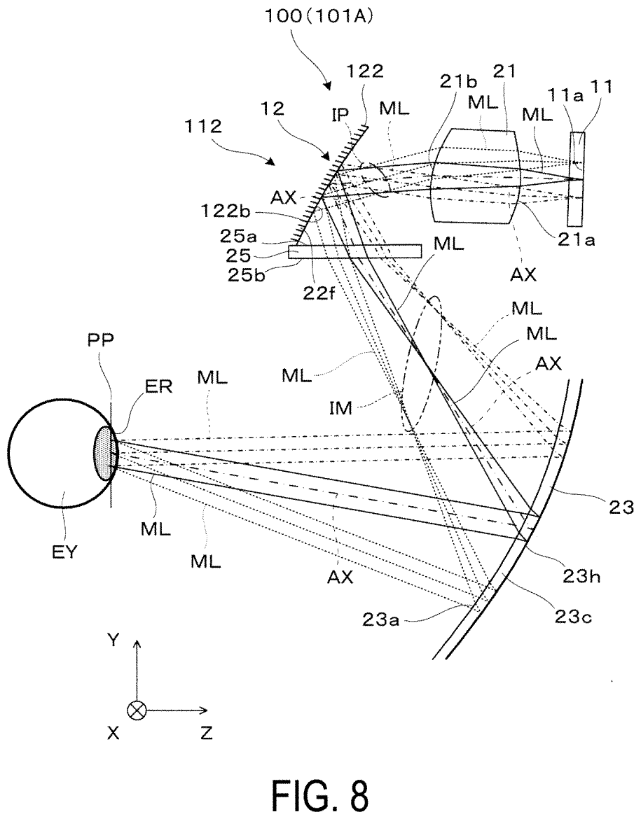

FIG. 8 is a side cross-sectional view illustrating an optical system of the virtual image display apparatus according to the second exemplary embodiment. The projection optical system (light-guiding device) 12 in the illustration includes the optical element 21, a reflecting mirror 122, the linear diffraction element 25, and the see-through hologram mirror 23.

The reflecting mirror 122 includes a reflecting surface 122b. Similarly to the internal reflecting surface (reflecting mirror) 22b of the prism 22 illustrated in FIG. 3 and the like, the reflecting surface 122b causes the image light ML from the optical element 21 to enter the see-through hologram mirror 23 through the linear diffraction element 25. The reflecting surface 122b is a free curved surface, for example. The reflecting surface 122b is not limited to a free curved surface, and may be an aspherical surface. The reflecting mirror 122 is formed on the surface of a base material 22f in such a way that a reflecting film formed of a single film or a multilayer film formed of metal such as Al and Ag is formed by vapor deposition or the like or that a sheet-like reflecting film formed of metal is attached.

### Modification Examples and Others

The present disclosure is described according to the above-mentioned exemplary embodiments, but the present disclosure is not limited to the above-mentioned exemplary embodiments. The present disclosure may be carried out in various modes without departing from the gist of the present disclosure, and, for example, the following modifications may be carried out.

The linear diffraction element 25 is not limited to a blazed diffraction grating, and, for example, may be a diffraction grating having a sinusoidal wavy cross-sectional shape.

In the linear diffraction element 25, the diffraction surface 25b is not required to be arranged on the emission side, and may be arranged on the incident side. The linear diffraction element 25 is not limited to be arranged between the prism 22 and the see-through hologram mirror 23, and may be arranged on the optical paths from the display element 11 to the see-through hologram mirror 23, for example, at any position between the prism 22 and the optical element 21 or between the optical element 21 and the display element 11. Further, in case where the optical element 21 includes a flat surface, or in a case where an additional optical element is arranged on the optical element 21, and the additional optical element includes a flat surface, the diffraction surface 25b may be formed on such a flat surface. When the prism 22 includes a flat surface, the diffraction surface 25b may be formed on the flat surface.

The optical element 21 is not limited to a lens, may be replaced with a prism, or may be obtained by combining a lens and a prism.

In the virtual image display apparatus 100 in the above-described exemplary embodiments, a self-luminous type display device such as an organic EL element, an LCD, or other light modulating elements are used as the display element 11. Instead, a configuration in which a laser scanner obtained by combining a laser light source and a scanner such as a polygon mirror may also be used. Specifically, the present disclosure is applicable to a laser retina projection type head-mounted display.

The hologram layer 23h of the see-through hologram mirror 23 may be formed on the surface 23a side instead of the surface 23b side.

A light control device that controls light by limiting light passing through the see-through hologram mirror 23 may be attached to the external side of the see-through hologram mirror 23. The light control device adjusts a transmittance, for example, electrically. Mirror liquid crystals, electronic shades, and the like may be used as the light control device. The light control device may adjust a transmittance according to external light brightness. When the light control device blocks the external light OL, only a virtual image that is not affected by an external image can be observed. Further, the virtual image display apparatus of the claimed disclosure is applicable to a so-called closed-type head-mounted display device (HMD) that blocks external light and causes only imaging light to be visually recognized. In this case, the HMD may also be compatible with a so-called see-through video product constituted by a virtual image display apparatus and an imaging device.

In the description above, the virtual image display apparatus 100 is assumed to be mounted and used on a head, but the virtual image display apparatus 100 described above may also be used as a hand-held display that is not mounted on a head and is viewed into it like a pair of binoculars. In other words, the head-mounted display also includes a hand-held display in the present disclosure.

The off-axis surface SO is set in the vertical direction or the Y direction as described above. However, lateral installation or lateral development in which the off-axis surface SO is set in the lateral direction or the X direction may be adopted.

A virtual image display apparatus according to a specific mode includes a display element, an optical element configured to pass therethrough image light emitted from the display element, a reflecting mirror configured to reflect the image light emitted from the optical element, a hologram mirror of a see-through type configured to reflect the image light, emitted from the reflecting mirror, to a pupil position, and a linear diffraction element of a transmissive type arranged on an optical path from the display element to the hologram mirror, wherein the optical element, the reflecting mirror, and the hologram mirror are arranged to form an off-axis system, and the linear diffraction element compensates wavelength dispersion caused by the hologram mirror at an off-axis surface of the off-axis system.

In the virtual image display apparatus, the optical element, the reflecting mirror, and the hologram mirror are arranged to form the off-axis system. While generation of aberration is suppressed by the reflecting mirror and the hologram mirror, size reduction of the optical system and size reduction of the apparatus as a whole can be achieved. Further, the linear diffraction element compensates wavelength dispersion caused by the hologram mirror on the off-axis surface of the off-axis system, and hence a resolution of a virtual image displayed by the virtual image display apparatus can be improved.

In a specific aspect, at the off-axis system, an optical path from the optical element to the reflecting mirror, an optical path from the reflecting mirror to the hologram mirror, and an optical path from the hologram mirror to the pupil position are arranged to be folded twice to have a Z-like shape. In this case, due to the folded optical paths, the display element and the optical element can be accommodated in a small space.

In another aspect, the linear diffraction element includes a diffraction pattern extending in a direction perpendicular to the off-axis surface of the off-axis system. In this case, with the diffraction pattern, wavelength dispersion in a direction along the off-axis surface can be compensated.

Further, in another aspect, the linear diffraction element is a blazed diffraction grating. In this case, optical attenuation due to the linear diffraction element can be suppressed, which contributes to improvement of brightness of a virtual image.

Further, in another aspect, primary diffraction light from the linear diffraction element enters the hologram mirror. In this case, utilization efficiency of light extracted from the linear diffraction element can be improved.

Further, in another aspect, the linear diffraction element is arranged between the reflecting mirror and the hologram mirror. In this case, the space for arranging the linear diffraction element can be secured easily.

Further, in another aspect, in an optical path of a main optical beam from a center of a display surface, a distance between the hologram mirror and the pupil position is equal to or less than a distance between the hologram mirror and the linear diffraction element. In this case, a projection amount by which the reflecting mirror and the optical element protrude in a periphery (upward-and-downward direction and right-and-left direction) of the see-through mirror can be suppressed.

Further, in another aspect, an intermediate image is formed between the linear diffraction element and the hologram mirror. In this case, the reflecting mirror can be small, and degradation of the intermediate image due to dirt and the like on the surface of the linear diffraction element can be suppressed.

Further, in another aspect, the intermediate image is formed closer to the linear diffraction element thanto the hologram mirror. In this case, a load of magnification due to the see-through mirror is reduced, and hence aberration of a virtual image to be observed can be suppressed.

Further, in another aspect, at the off-axis surface of the off-axis system, a hologram layer of the hologram mirror is oriented in a direction further to an optical axis at an emission side of the hologram layer than to an optical axis at an incident side of the hologram layer. In this case, the posture of the hologram mirror can be close to the vertical direction parallel with the off-set surface and parallel with a pupil surface at the pupil position, and the hologram mirror can be prevented from being increased in thickness.

Further, in another aspect, the hologram mirror has a shape in which an original point in a curved surface expression is shifted to the optical element side from an effective area of the hologram mirror. In the optical system, with respect to the direction perpendicular to the off-axis surface of the off-axis system, image formation utilizing a curvature of the hologram mirror is performed. As described above, by shifting the original point in the curved surface expression to the side of the optical element, an inclination surface of the hologram mirror, which achieves the Z-like shape optical paths, can be set without putting an excessive load to design of the optical system.

Further, in another aspect, an image displayed at the display element has a distortion that cancels a distortion formed by the optical element, the reflecting mirror, and the hologram mirror. In this case, distortion aberration generated at the hologram mirror or the like is allowed, and aberration as a whole including the display element can be suppressed.

Further, in another aspect, at the off-axis surface of the off-axis system, an intermediate pupil is arranged between the optical element and the reflecting mirror. Further, a focal distance is easily reduced, and a magnification is easily increased. Thus, while the display element approaches the reflecting mirror and the like, the display element can be small.

Further, in another aspect, the optical element, the reflecting mirror, and the hologram mirror have an optically symmetric shape with respect to a direction orthogonal to the off-axis surface of the off-axis system. In this case, the intersecting direction orthogonal to the off-axis surface is close to general optical design.

Further, in another aspect, a direction orthogonal to the off-axis system corresponds to a lateral direction in which eyes are aligned, and the reflecting mirror has a lateral width in the lateral direction, the lateral width being larger than a vertical width in a vertical direction orthogonal to the lateral direction. In this case, the angle of view in the lateral direction can be increased. Further, even when the line-of-sight is largely changed in the lateral direction correspondingly to the eye that moves largely in the lateral direction, the image can be visually recognized.

Further, in another aspect, the optical element is arranged to be interposed between the reflecting mirror and the display element in a lateral direction orthogonal to the off-axis system and in a front surface direction orthogonal to a vertical direction orthogonal to the lateral direction. In this case, the optical path from the reflecting mirror to the display element is close to the front surface direction, and the optical paths from the optical element to the pupil position through the reflecting mirror and the hologram mirror can be arranged while being folded twice in a Z-like shape, as seen in the lateral direction.

A light-guiding device according to one aspect of the present disclosure includes an optical element configured to pass therethrough image light emitted from a display element, a reflecting mirror configured to reflect the image light emitted from the optical element, a hologram mirror of a see-through type configured to reflect the image light, emitted from the reflecting mirror, to a pupil position, and a linear diffraction element of a transmissive type arranged at an optical path from the display element to the hologram mirror, wherein the optical element, the reflecting mirror, and the hologram mirror are arranged to form an off-axis system, and the linear diffraction element compensates wavelength dispersion caused by the hologram mirror at an off-axis surface of the off-axis system.

In the light-guiding device, the optical element, the reflecting mirror, and the hologram mirror are arranged to form the off-axis system. While generation of aberration is suppressed by the reflecting mirror and the hologram mirror, size reduction of the optical system and size reduction of the apparatus as a whole can be achieved. Further, the linear diffraction element compensates wavelength dispersion caused by the hologram mirror on the off-axis surface of the off-axis system, and hence a resolution of a virtual image displayed by the virtual image display apparatus can be improved.

What is claimed is:

1. A virtual image display apparatus, comprising:
a display element;
an optical element configured to pass therethrough image light emitted from the display element;
a reflecting mirror configured to reflect the image light emitted from the optical element;
a hologram mirror of a see-through type configured to reflect the image light, emitted from the reflecting mirror, to a pupil position; and
a linear diffraction element of a transmissive type arranged at an optical path from the display element to the hologram mirror, wherein
the optical element, the reflecting mirror, and the hologram mirror are arranged to form an off-axis system, and
the linear diffraction element compensates wavelength dispersion caused by the hologram mirror at an off-axis surface of the off-axis system.

2. The virtual image display device according to claim 1, wherein
at the off-axis system, an optical path from the optical element to the reflecting mirror, an optical path from the reflecting mirror to the hologram mirror, and an optical path from the hologram mirror to the pupil position are arranged to be folded twice to have a Z-like shape.

3. The virtual image display device according to claim 1, wherein
the linear diffraction element includes a diffraction pattern extending in a direction perpendicular to the off-axis surface of the off-axis system.

4. The virtual image display apparatus according to claim 3, wherein
the linear diffraction element is a blazed diffraction grating.

5. The virtual image display device according to claim 1, wherein
primary diffraction light from the linear diffraction element enters the hologram mirror.

6. The virtual image display device according to claim 1, wherein
the linear diffraction element is arranged between the reflecting mirror and the hologram mirror.

7. The virtual image display device according to claim 6, wherein
in an optical path of a main optical beam from a center of a display surface, a distance between the hologram mirror and the pupil position is equal to or less than a distance between the hologram mirror and the linear diffraction element.

8. The virtual image display device according to claim 7, wherein
an intermediate image is formed between the linear diffraction element and the hologram mirror.

9. The virtual image display device according to claim 8, wherein
the intermediate image is formed closer to the linear diffraction element than to the hologram mirror.

10. The virtual image display device according to claim 1, wherein
at the off-axis surface of the off-axis system, a hologram layer of the hologram mirror is oriented in a direction further to an optical axis at an emission side of the hologram layer than to an optical axis at an incident side of the hologram layer.

11. The virtual image display device according to claim 1, wherein
the hologram mirror has a shape in which an original point in a curved surface expression is shifted to the optical element side from an effective area of the hologram mirror.

12. The virtual image display device according to claim 1, wherein
an image displayed at the display element has a distortion that cancels a distortion formed by the optical element, the reflecting mirror, and the hologram mirror.

13. The virtual image display device according to claim 1, wherein
at the off-axis surface of the off-axis system, an intermediate pupil is arranged between the optical element and the reflecting mirror.

14. The virtual image display device according to claim 1, wherein
the optical element, the reflecting mirror, and the hologram mirror have an optically symmetric shape with respect to a direction orthogonal to the off-axis surface of the off-axis system.

15. The virtual image display device according to claim 14, wherein
a direction orthogonal to the off-axis system corresponds to a lateral direction in which eyes are aligned, and the reflecting mirror has a lateral width in the lateral direction, the lateral width being larger than a vertical width in a vertical direction orthogonal to the lateral direction.

16. The virtual image display device according to claim 1, wherein
the optical element is arranged to be interposed between the reflecting mirror and the display element in a lateral direction orthogonal to the off-axis system and in a front surface direction orthogonal to a vertical direction orthogonal to the lateral direction.

17. A light-guiding device, comprising:
an optical element configured to pass therethrough image light emitted from a display element;
a reflecting mirror configured to reflect the image light emitted from the optical element;
a hologram mirror of a see-through type configured to reflect the image light, emitted from the reflecting mirror, to a pupil position; and
a linear diffraction element of a transmissive type arranged at an optical path from the display element to the hologram mirror, wherein
the optical element, the reflecting mirror, and the hologram mirror are arranged to form an off-axis system, and
the linear diffraction element compensates wavelength dispersion caused by the hologram mirror at an off-axis surface of the off-axis system.
